(19) United States
(12) Patent Application Publication
(10) Pub. No.: US 2012/0058255 A1
(43) Pub. Date: Mar. 8, 2012

(54) CARBON NANOTUBE-CONDUCTIVE POLYMER COMPOSITES, METHODS OF MAKING AND ARTICLES MADE THEREFROM

(75) Inventors: Thomas Kok Sim Gan, Singapore (SG); Mui Hoon Nai, Singapore (SG); Jonathan Sim, Singapore (SG); Charles Baudot, Singapore (SG); Solomon Ubong Udo, Singapore (SG); Nripan Mathews, Singapore (SG); Subodh Mhaisalkar, Singapore (SG); Cher Ming Tan, Singapore (SG)

(73) Assignees: NANYANG TECHNOLOGICAL UNIVERSITY, Singapore (SG); STMICROELECTRONICS ASIA PACIFIC PTE LTD., Singapore (SG)

(21) Appl. No.: 12/877,432

(22) Filed: Sep. 8, 2010

(51) Int. Cl. B05D 5/12; H01B 1/02; H01B 1/04; H01B 1/12

(52) U.S. Cl. 427/113; 252/500; 252/519.21; 252/511; 977/742; 977/746

(57) ABSTRACT

Electrically conductive polymer materials, such as mixtures of poly(3,4-ethylenedioxythiophene) (PEDOT) and poly(styrenesulfonate) (PSS) are combined with functionalized carbon nanotubes to form composites that exhibit increased electrical conductivity. Functionalized or non-functionalized carbon nanotubes combined with the same electrically conductive polymer materials are combined with non-conductive polymers to increase the electrical conductivity of the non-conductive polymer. The functionalized carbon nanotubes are functionalized with carboxyl and/or hydroxyl groups. The resulting materials are useful in methods of forming electrically conductive films and electrically conductive features.

### BACKGROUND

1. Technical Field

The subject matter of this application relates to composites of carbon nanotubes and conductive polymer materials, such as mixtures of poly(3,4-ethylenedioxythiophene) and poly(styrenesulfonate) (PEDOT:PSS), articles made from such composites, and methods of making such composites and articles.

2. Description of the Related Art

In the past, copper has been a promising candidate for electronic device applications such as RFID antenna applications due to its high conductivity (10⁵ S/cm) and low cost.

Other known materials with high conductivity suitable for large area deposition require deposition and patterning of metals either via soluble precursor deposition (e.g., by printing) and electrocatalytic growth processes or via direct printing of metal inks composed by metal nanoparticles in an organic matrix. In both cases, the processes have their drawbacks. For example, in the case of deposition of precursors and electrocatalytic growth, the high number of process steps contributes to the relatively high cost of the manufacturing process. In the case of printing metal inks, sintering is required and the processing temperatures required for sintering are generally not compatible with low cost organic matrices. In addition, it has been reported that when metal nanoparticles are incorporated into an organic polymer matrix to form metal inks, the amount of nanoparticles required leads to a high materials cost.

More recently, in electronic device applications, organic materials have received attention as an alternative to conventional conductive materials, such as copper, due to the attractive cost of organic materials and the types of processing that can be utilized with organic materials. For example, patterning of organic polymer materials is feasible using cost effective large area deposition techniques such as stencil and doctor blade depositions. For some applications, it is desirable to increase the conductivity of an organic polymer material (conductive or non-conductive), making the organic material more suitable for the particular application.

Carbon nanotubes are allotropes of carbon with a cylindrical nanostructure. These cylindrical carbon molecules have novel properties that make them potentially useful in many applications in nanotechnology, electronics, optics and other fields of materials science. They are efficient thermal conductors and exhibit unique strength and electrical properties. Carbon nanotubes also pose health risks if inhaled. Accordingly, it is desirable to sequester the carbon nanotubes in a matrix or process them in a way that reduces or prevents the availability of the carbon nanotubes for inhalation.

### BRIEF SUMMARY

In one aspect the following description relates to functionalized carbon nanotubes that are combined with conductive polymer materials to form composites that exhibit electrical conductivity greater than the electrical conductivity of the conductive polymers themselves. For example in an embodiment of the type of polymer composites described herein, a polymer composite includes an electrically conductive polymer material and carbon nanotubes including functional groups selected from the group consisting of carboxyl and hydroxyl groups. Electrically conductive films can be formed by providing a substrate and depositing a composite that includes an electrically conductive polymer material and carbon nanotubes including functional groups selected from the group consisting of carboxyl and hydroxyl groups. The described polymer composites and methods of forming conductive films are useful for forming electrically conductive features on a substrate.

In another aspect, the following description relates to functionalized or non-functionalized carbon nanotubes combined with conductive polymer materials to form a composite that is then added to non-conductive or dielectric materials to impart electrical conductivity to the otherwise dielectric materials. For example in another embodiment of the description herein, the polymer composite includes an electrically conductive polymer material, carbon nanotubes and a dielectric material. Films can be formed from these composites by providing a substrate and depositing a composite that includes an electrically conductive polymer material, carbon nanotubes, and a dielectric material. The carbon nanotubes can be functionalized with carboxyl or hydroxyl groups or they can be free of functionalization. The described polymer composites and methods of forming conductive films are useful for forming electrically conductive features on a substrate.

### BRIEF DESCRIPTION OF THE SEVERAL VIEWS OF THE DRAWINGS

FIG. 1 is a graph illustrating electrical conductivity versus weight percent carbon nanotubes of a composite of functionalized carbon nanotubes combined with a conductive polymer material in accordance with embodiments described herein;

FIG. 2 is a graph illustrating electrical conductivity versus weight percent carbon nanotubes of a composite of functionalized carbon nanotubes combined with a conductive polymer material in accordance with embodiments described herein;

FIG. 3 is a graph illustrating electrical conductivity versus weight percent carbon nanotubes of a composite of functionalized carbon nanotubes combined with a conductive polymeric material in accordance with embodiments described herein;

FIG. 4 is a graph illustrating electrical conductivity versus weight percent carbon nanotubes of a composite of functionalized carbon nanotubes combined with a conductive polymer material in accordance with embodiments described herein;

FIG. 5 is a scanning electron microscope image of a conductive polymer mixture combined with non-functionalized carbon nanotubes in accordance with embodiments described herein; and

FIG. 6 is a scanning electron microscope image of a carbon nanotube matrix remaining after a composite of a non-conductive polymer and carbon nanotubes is etched with acetone.

### DETAILED DESCRIPTION

Electrically conductive polymers are organic polymers capable of conducting electricity. While most organic polymers are considered to be insulators, the class of conductive polymers or intrinsically conducting polymers is able to conduct electricity. Advantages of conductive polymers are their processability and mechanical properties such as flexibility, toughness, and elasticity. Conductive organic polymers include those that have structures corresponding to polyacetylene, polyphenylenevinylene, polypyrrole, polythiophene, polyaniline, and polyphenylene sulfide. The present description proceeds with reference to a conductive polymer material that is a mixture of poly(3,4-ethylenedioxythiophene) (PEDOT) and poly(styrenesulfonate) (PSS). It should be understood that as used herein, conductive polymer material refers to mixtures of two or more conductive polymers such as PEDOT:PSS or individual polymers. PEDOT:PSS products are available from N.C. Starck GmbH of Goslar, Germany and AGFA of Mortsel, Belgium.

Carbon nanotubes, or CNTs as they are otherwise known, are allotropes of carbon with a cylindrical nanostructure. CNTs come in a variety of diameters and lengths. They may consist of one tube of graphite, a one-atom thick single-walled nanotube (SWNT), a two-atom thick double-walled carbon nanotube (DWNT) or a number of concentric tubes referred to as multi-walled nanotubes (MWNT). Three types of SWNT structures are zigzag, armchair, and chiral. MWNTs come in even more complex forms because each concentric nanotube can have different structures, and hence there are a variety of sequential arrangements. The simplest sequence is when concentric layers are identical but different in diameter. However, mixed variants are possible, consisting of one or more types of concentric CNTs arranged in different orders. For the purposes of the description below, SWNTs and MWNTs are referenced. For the purposes of the subject matter described herein, carbon nanotubes exhibiting conductivity on the order of 100 Siemens per centimeter (S/cm), or greater, are preferred for the purpose of increasing the electrical conductivity of the conductive polymer to which they are added; however, carbon nanotubes exhibiting conductivity less than 100 S/cm are also suitable for use in the embodiments described herein.

In accordance with the embodiments described herein, it is preferred that the CNTs are functionalized. Functionalization refers to a process wherein functional groups are physically or chemically attached to the surfaces of the CNTs. Functionalization of CNTs can be achieved using known processes as described in more detail below. In addition, functionalized SWNTs and MWNTs can be obtained from commercial sources such as CheapTubes, Inc (cheaptubes.com) of Brattleboro, Vt., and Carbon Solutions, Inc. of Riverside, Calif. Examples of suitable functional groups include carboxyl (—COOH), hydroxyl (—OH) and silver carboxylate (—COOAg) groups. The functionalization of the CNTs achieves at least one or more of the following objectives:
1. Improves the solubility and dispersibility of the CNTs in water and conductive polymer materials into which the CNTs are to be mixed in accordance with the embodiments described herein;
2. Reduces contact resistance between CNTs incorporated into the conductive polymer material by drawing the CNTs closer together; and
3. Provides a conductive bridge between CNTs to reduce the electrical contact resistance therebetween.

Taking into consideration the foregoing criteria, carboxyl groups (—COOH) are a preferred functional group that can be chemically attached to the CNT's because they render the CNT more soluble in water and conductive polymer materials. In addition, carboxyl groups can form hydrogen bonds between carbonyl and hydroxyl groups of two different CNTs that contain carboxyl groups, thus drawing the CNTs closer together and effectively reducing electrical contact resistance between the CNTs. Hydroxyl groups, while effective at increasing the solubility and dispersibility of the CNTs, are less effective at reducing contact resistance, compared to carboxyl groups. Finally, although silver carboxylate groups do not have a significant effect on the solubility of the CNTs in water or conductive polymer materials, they act as a conductive bridge between adjacent CNTs resulting in a lowering of the contact resistance between CNTs. In some embodiments, conductive polymers themselves are suitable materials to provide a conductive bridge between adjacent CNT's.

CNTs can be functionalized with carboxyl groups using known techniques such as by sonicating pristine CNTs in an acid bath of sulfuric acid and nitric acid in the ratio of 3:1 for an extended period of time, such as 6 hours. In this manner, carboxyl groups can be attached to the sidewalls of the CNTs. Hydroxyl groups can be attached to the sidewalls of CNTs using similar known techniques. Silver carboxylate groups can be attached to the CNTs by dispersing CNTs that have been functionalized with carboxyl groups in deionized water and stirring in a sodium hydroxide alkaline solution together with a silver nitrate solution for approximately 2 hours. During stirring, the silver ions replace the hydrogen ions of the carboxyl groups to form silver carboxylate groups. It should be understood that the foregoing descriptions of techniques for functionalizing CNTs to include carboxyl, hydroxyl, and silver carboxylate groups are exemplary and that the embodiments described herein are not limited to functionalizing CNTs with carboxyl, hydroxyl, or silver carboxylate groups utilizing the techniques described above.

The degree to which the CNTs are functionalized is a balance between introducing the desired functional groups into the CNTs to achieve one or more of the three objectives described above, while minimizing the effect on the desirable intrinsic properties of the CNTs. For example, while a greater degree of functionalization may improve the dispersibility of the CNTs, such improvement may come at a decrease in intrinsic properties of the pristine CNTs. In accordance with the embodiments described herein, suitable functionalization with carboxyl or hydroxyl groups ranged from about 2.5 to about 10 wt %.

It is known that electrical conductivity of conductive polymer materials such as PEDOT:PSS can be increased by adding organic solvents such as dimethyl sulfoxide (DMSO), N,N-dimethyl formamide (DMF), or tetra-hydrofuran (THF). For the purposes of the description that follows, the conductive polymer material includes compositions made up of a conductive polymer material or a mixture of a conductive polymer material and a solvent such as DMSO, DMF, or THF.

Functionalized carbon nanotube/conductive polymer material composites described herein are formed by mixing the electrically conductive polymer material and functionalized CNTs. Generally such mixing can be achieved by adding the functionalized CNTs to the conductive polymer material directly and sonicating the mixture to uniformly disperse the functionalized CNTs in the conductive polymer material. During the dispersion, a conductivity enhancing solvent, such as 5 wt % DMSO, may be added to the mixture as a dopant. The solution containing the DMSO is then stirred to obtain a homogenous dispersion which allows the dispersion to be formed using well known large area deposition techniques such as a doctor blade method.

The amount of functionalized CNTs mixed with the conductive polymer material can vary. One advantage of the embodiments described herein is that increases in electrical conductivity of conductive polymer materials has been observed utilizing 1 wt % or less functionalized carbon nanotubes in the conductive polymer material. The specific amount of functionalized CNTs mixed with the conductive polymer material will depend upon, among other things, the amount of increase in electrical conductivity desired and the type of conductive polymer material. Generally speaking, any amount of CNTs that provides the desired increase in electrical conductivity of the conductive polymer material can be utilized. As illustrated herein, significant increases in the electrical conductivity of conductive polymer materials can be achieved utilizing functionalized CNTs in amounts of 5 wt % or less and even 1 wt % or less. Generally, the amount of functionalized CNTs utilized will be limited to those amounts below which agglomeration of the CNTs within the polymer material matrix is avoided. Agglomeration of the CNTs within the polymer material matrix is undesirable because it results in formation of voids and aggregates in the composite which adversely affects the electrical conductivity properties of the composite as well as the physical properties of the composite.

Further description of embodiments for combining functionalized CNTs with conductive polymer materials and the formation of thin films from the formed composite are provided below in the following examples.

### Example 1

### Functionalized SWNTs Combined with PEDOT:PSS

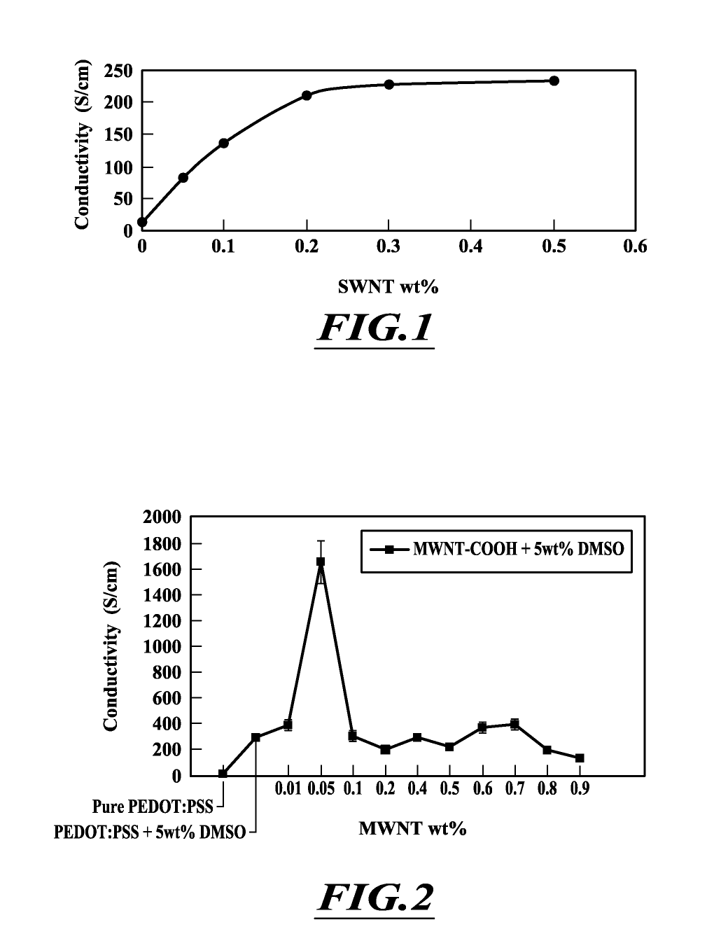

In this Example 1, functionalized SWNTs obtained from Carbon Solutions, Inc. of Riverside, Calif. under the product number P3-SWNT were used. The functionalized SWNTs include about 1.0 to 3.0 atomic % carboxyl groups (—COOH) (about 3.65 to 10.39 weight % carboxyl groups). The functionalized SWNTs were added in an amount ranging from 0.05 wt % to 0.5 wt % directly to PEDOT:PSS conductive polymer material available from N.C. Starck under the product identifier PHCV4, and sonicated for 1 hour and then stirred for 8 hours. The resulting mixtures were formed into lines on a substrate using a doctor blade method. The lines ranged in width from 0.2 mm to 2 mm, had a length of 45 mm and a thickness of approximately 5 mm. The conductive lines were tested using a four-point probe tester to determine their electrical conductivity. The results of those tests are illustrated in FIG. 1. The pure PEDOT:PSS line exhibited an electrical conductivity of 11.17 S/cm. FIG. 1 shows that the addition of 0.05 wt % of the functionalized SWNTs resulted in over a seven times increase in electrical conductivity compared to pure PEDOT:PSS. In addition, as the concentration of the functionalized SWNTs increased from 0.05 wt % to 0.2 wt %, the electrical conductivity of the film increased from 81.69 S/cm to 210.4 S/cm. With increased loading above 0.2 wt %, the electrical conductivity continued to increase moderately. When loading of functionalized SWNTs approached 0.5 wt %, the conductivity of the composite film was 233.55 S/cm. The results of this example illustrate that electrical conductivity of PEDOT:PSS can be increased by introducing SWNTs functionalized with 1.0 to 3.0 atomic % carboxyl groups into PEDOT:PSS.

### Example 2

### Functionalized MWNTs Combined with Different Grades of PEDOT:PSS

### A. High Conductive and High Viscosity Grade PEDOT:PSS

In this example, MWNTs functionalized with 2.5 wt % carboxyl groups, obtained from Cheap Tubes Inc. (cheaptubes.com) of Brattleboro, Vt. under the product identifier COOH Functionalized Nanotubes-COOH-MWNTs 8-15 nm, were mixed with a high conductive and viscosity grade PEDOT:PSS available from N.C. Starck under the product identifier PHCV4. The functionalized MWNTs were mixed with the PEDOT:PSS in the same manner as described in Example 1. During the dispersion of the MWNTs in the PEDOT:PSS, 5 wt % of DMSO was added and the mixture stirred to obtain a homogeneous dispersion. The amount of functionalized MWNTs added to the PEDOT:PSS varied from 0 wt % to 0.9 wt %. The electrical conductivity of the resulting composites was determined as described in Example 1. The results of the electrical conductivity measurements for pure PEDOT:PSS, PEDOT:PSS+5 wt % DMSO, and PEDOT:PSS+5 wt % DMSO+MWNT-COOH are presented in FIG. 2. This example illustrates how the addition of the described functionalized MWNTs into PEDOT:PSS doped with 5 wt % DMSO increases the electrical conductivity of the pure PEDOT:PSS and the PEDOT:PSS doped with 5 wt % DMSO. Of note is that for the described combination of functionalized MWNTs and PEDOT:PSS doped with DMSO, the increase in electrical conductivity peaks when the amount of the functionalized MWNTs added was about 0.05 wt %.

### B. Low Conductivity and Low Viscosity Grade PEDOT:PSS

MWNTs functionalized with 2.5 wt % carboxyl groups and MWNTs functionalized with 3.7 wt % hydroxyl groups obtained from Cheap Tubes, Inc. (cheaptubes.com) of Brattleboro, Vt. under the product identifiers COOH

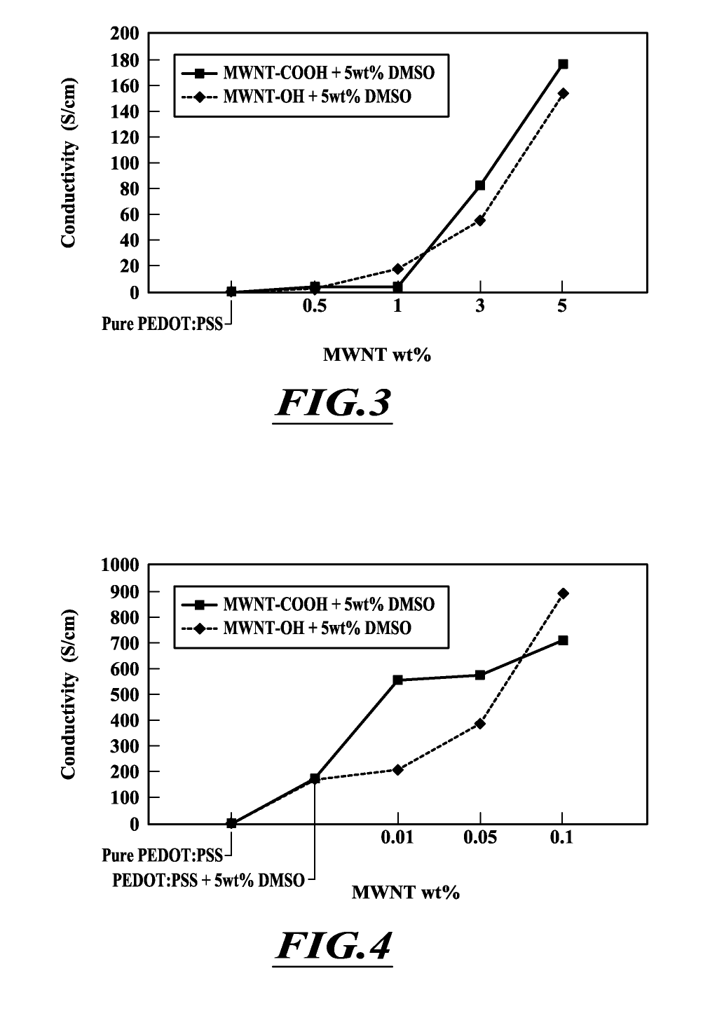

Functionalized Nanotubes-COOH-MWNTs 8-15 nm and OH Functionalized Nanotubes-OH-MWNTs 8-15, respectively, were separately mixed with a low conductivity and low viscosity grade PEDOT:PSS available from N.C. Starck under the product number AL4083 along with 5 wt % DMSO as described in A. above. The amount of functionalized MWNTs added to the PEDOT:PSS ranged from 0.5 wt % to 5 wt %. The two resulting composites were formed into films and the electrical conductivity of the films was evaluated as described in Example 1. The results are presented in FIG. 3. FIG. 3 illustrates how the addition of the described —COOH functionalized MWNTs and —OH functionalized MWNTs increased the electrical conductivity of the AL4083 PEDOT:PSS conductive polymer material. A comparison of the results in this example and the results of Example 2.A. above suggests a greater amount of functionalized MWNT's are needed to increase the electrical conductivity of a low viscosity grade PEDOT:PSS compared to the amount of functionalized MWNT's needed to increase the electrical conductivity of a high viscosity grade PEDOT:PSS.

### C. High Conductivity and Low Viscosity Grade PEDOT:PSS

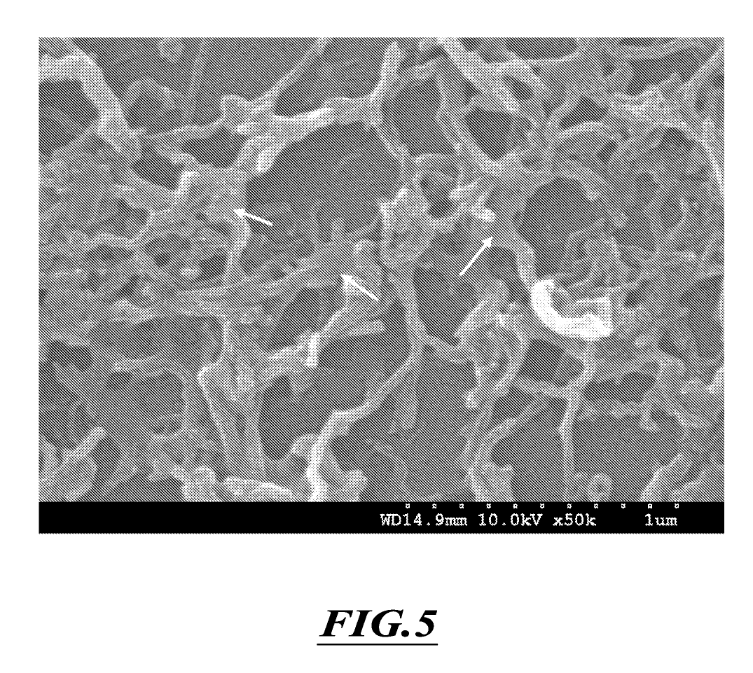

A high conductivity and low viscosity PEDOT:PSS available from N.C. Starck under the product identifier PH500 was mixed with two different MWNTs, one functionalized with 2.5 wt % carboxyl groups and the other functionalized with 3.7 wt % hydroxyl groups. These MWNTs were obtained from Cheap Tubes, Inc. (cheaptubes.com) of Brattleboro, Vt. under the product identifiers COOH Functionalized Nanotubes-COOH-MWNTs 8-15 nm and OH Functionalized Nanotubes-OH-MWNTs 8-15. The mixture included 5 wt % DMSO and was formed as described above in A. The functionalized MWNTs were added to the PEDOT:PSS in an amount ranging from 0.01 wt % to 0.1 wt %. The mixture was formed into films and tested for electrical conductivity as described above with regard to Example 1. FIG. 4 illustrates the measured electrical conductivity of the formed films. FIG. 4 illustrates how the addition of functionalized MWNTs to the PEDOT:PSS increases the electrical conductivity of the PEDOT:PSS conductive polymeric material.

As with Example 2.B. above, a comparison of the results in this example and the results of Example 2.A. above suggests a greater amount of functionalized MWNT's are needed to increase the electrical conductivity of a low viscosity grade PEDOT:PSS compared to the amount of functionalized MWNT's needed to increase the electrical conductivity of a high viscosity grade PEDOT:PSS.

In accordance with another aspect of the subject matter described herein, composites of carbon nanotubes (functionalized or non-functionalized) and electrically conductive polymer materials described above are combined with a dielectric material to impart electrical conductivity to the otherwise nonconductive dielectric material. Examples of dielectric materials to which the conductive polymer/carbon nanotube composites of the described embodiments can be added include polyurethanes, polystyrenes, and epoxies.

The following example compares the results achieved when carbon nanotubes are added directly to a dielectric material and the results achieved when a composite of CNT/conductive polymer is added to a dielectric material. It should be understood that functionalized CNTs in combination with electrically conductive polymer materials can also be added to non-conductive dielectric materials to impart electrical conductive properties to the otherwise non-conductive dielectric material.

### Example 3

### Combination of Carbon Nanotubes and Carbon Nanotube-Conductive Polymer Composite with Dielectric Material

Two wt % of a pristine (non-functionalized) MWNT obtained from NTP China of Shenzhen, China, under the product identifier L-MWNT-4060 was added to 330 mg of PEDOT:PSS obtained from H.C. Starck under the product identifier AL4083. The MWNTs were added to the PEDOT:PSS by first dispersing the MWNTs in dimethylformamide (DMF) and sonicating until a uniform suspension was formed. The resulting suspension was then added to the PEDOT:PSS and further sonicated until a stable mixture was obtained. The resulting MWNT/PEDOT:PSS mixture was added to 330 mgs of polymethyl methacrylate (molecular weight 950) and the combination was sonicated until a stable mixture was formed. The resulting 1 wt % MWNT/PEDOT:PSS/PMMA mixture was stirred and heated at 100° C. for a period of time sufficient to evaporate the DMF solvent.

For comparison purposes, 1 wt % of a pristine (non-functionalized) MWNT obtained from NTP China of Shenzhen, China, under the product identifier L-MWNT-4060 was added to 660 mg of PMMA. The MWNTs were added to the PMMA by first dispersing the MWNTs in dimethylformamide (DMF) and sonicating until a uniform suspension was formed. The resulting suspension was then added to the PMMA and further sonicated until a stable mixture was obtained. The resulting 1 wt % MWNT/PMMA mixture was stirred and heated at 100° C. for a period of time sufficient to evaporate the DMF solvent.

Films 50 nm thick were formed by spin coating the MWNT/PEDOT:PSS/PMMA and the MWNT/PMMA mixtures at 1000 rpms for about 30 seconds. Films of similar thickness were formed from PMMA and a 50/50 wt % PEDOT:PSS/PMMA mixture. Electrical measurements were then taken utilizing the four point probe test system described in Example 1.

The conductivity test showed the PMMA film exhibited no conductivity. No significant conductivity was observed for the MWNT/PMMA film, while low electrical conductivity of 0.27 S/cm was observed for a PEDOT:PSS-PMMA composite film without the addition of MWNTs. The presence of 1 wt % MWNTs in the PEDOT:PSS/PMMA composite produced a composite having an electrical conductivity of 4.8 S/cm.

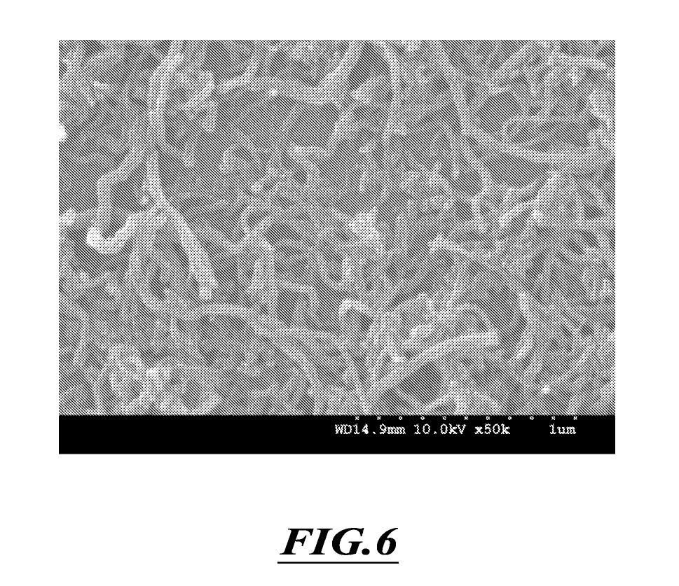

Acetone vapor was used to selectively remove the PMMA polymer from the films formed from the MWNT/PMMA mixture and the MWNT/PEDOT:PSS/PMMA composite. Both the MWNTs and the PEDOT:PSS were resistant to etching or dissolving by the acetone, and therefore, the MWNTs and PEDOT:PSS remained after the acetone treatment. FIG. 5 is a scanning electron microscope image of the MWNT/PEDOT:PSS/PMMA composite after the acetone treatment. FIG. 5 illustrates the presence of a random interconnected network of MWNTs and PEDOT:PSS. The arrows in FIG. 5 identify locations where the PEDOT:PSS effectively wraps around and binds with the MWNTs to form a percolated network. A percolated network refers to the network of CNTs and conductive polymer that form a continuous conductive path extending through the composite. The presence of such continuous conductive path through the composite is believed to be a reason why the electrical conductivity of the conductive polymer material increases when CNTs are present. FIG. 6 is a scanning electron microscope image of the MWNT/PMMA composite after acetone treatment. In contrast to the MWNT/PEDOT:PSS/PMMA composite illustrated in FIG. 5, after PMMA is removed from the MWNT/PMMA composite, a random interconnected network of MWNTs also exists. However, electrical characterization prior to the etching showed the composite exhibited no significant electrical conductivity. This indicates that wrapping of the non-conducting PMMA around the MWNTs results in high resistance contact points formed between adjacent MWNTs rendering the overall MWNT/PMMA composite non-conducting.

The carbon nanotube-conductive polymer material composites described herein can be used to form conductive features on various types of substrates, such as glasses and plastics. For example, the composites described herein can be deposited using known doctor blade or stencil techniques to form RFID antennas or other nonintegrated conductive lines. In addition, the composites described herein can be used to form conductive films for transparent electrodes, flexible films or electromagnetic interference shielding applications.

The various embodiments described above can be combined to provide further embodiments. All of the U.S. patents, U.S. patent application publications, U.S. patent applications, foreign patents, foreign patent applications and non-patent publications referred to in this specification and/or listed in the Application Data Sheet are incorporated herein by reference in their entirety. Aspects of the embodiments can be modified, if necessary to employ concepts of the various patents, applications and publications to provide yet further embodiments.

These and other changes can be made to the embodiments in light of the above-detailed description. In general, in the following claims, the terms used should not be construed to limit the claims to the specific embodiments disclosed in the specification and the claims, but should be construed to include all possible embodiments along with the full scope of equivalents to which such claims are entitled. Accordingly, the claims are not limited by the disclosure.

1. A polymer composite comprising:
an electrically conductive polymer material; and
carbon nanotubes including functional groups selected from the group consisting of carboxyl and hydroxyl groups.

2. The composite of claim 1, wherein the conductive polymer material is a mixture of poly (3,4-ethylenedioxythiopene) and poly(styrenesulfonate).

3. The composite of claim 1, wherein the functional groups are carboxyl groups.

4. The composite of claim 3, wherein the carboxyl groups comprise at least about 2.5 weight percent of the carbon nanotubes.

5. The composite of claim 3, wherein the carboxyl groups are silver carboxylate groups.

6. The composite of claim 1, wherein the functional groups are hydroxyl groups.

7. The composite of claim 6, wherein the hydroxyl groups comprise at least about 2.5 weight percent of the carbon nanotubes.

8. The composite of claim 1, further comprising a dielectric material.

9. The composite of claim 8, wherein the dielectric material is selected from the group consisting of poly-methyl methacrylate, polyurethane, polystyrene and epoxies.

10. The polymer composite of claim 1, wherein the carbon nanotubes are present in an amount equal to or less than 1 weight percent.

11. A method of forming an electrically conductive film comprising:
providing a substrate; and
depositing onto the substrate a composite comprising an electrically conductive polymer material and carbon nanotubes including functional groups selected from the group consisting of carboxyl and hydroxyl groups.

12. The method of claim 11, further comprising patterning the deposited composite.

13. The method of claim 11, wherein the conductive polymer material is a mixture of poly (3,4-ethylenedioxythiopene) and poly(styrenesulfonate).

14. The method of claim 11, wherein the functional groups are carboxyl groups.

15. The method of claim 14, wherein the carboxyl groups are silver carboxylate groups.

16. The method of claim 11, wherein the functional groups are hydroxyl groups.

17. The method of claim 10, wherein the carbon nanotubes are present in an amount equal to or less than 1 weight percent.

18. A polymer composite comprising:
an electrically conductive polymer material;
carbon nanotubes; and
a dielectric material.

19. The polymer composite of claim 18, wherein the carbon nanotubes include functional groups selected from the group consisting of carboxyl and hydroxyl groups.

20. The polymer composite of claim 18, wherein the conductive polymer material is a mixture of poly (3,4-ethylenedioxythiopene) and poly(styrenesulfonate).

21. The polymer composite of claim 18, wherein the dielectric material is selected from the group consisting of poly-methyl methacrylate, polyurethane, polystyrene and epoxies.

22. The polymer composite of claim 18, wherein the conductive polymer material forms a percolated network with the carbon nanotubes.
